(19) United States
(12) Patent Application Publication
(10) Pub. No.: US 2012/0080973 A1
(43) Pub. Date: Apr. 5, 2012

(54) ARMATURE FOR ROTARY ELECTRIC APPARATUS AND MANUFACTURING METHOD FOR THE SAME

(75) Inventors: Yuya FURUKAWA, Kosai-city (JP); Yoshimasa Kinpara, Toyohashi-city (JP)

(73) Assignee: ASMO CO., LTD., Kosai-city (JP)

(21) Appl. No.: 13/246,089

(22) Filed: Sep. 27, 2011

(30) Foreign Application Priority Data
Oct. 4, 2010 (JP) 2010-224875
Feb. 7, 2011 (JP) 2011-024067

(51) Int. Cl. H02K 1/22; H02K 15/02

(52) U.S. Cl. 310/195; 29/598

(57) ABSTRACT

A laminated core includes laminated core sheets each formed by press working. Each core sheet has a teeth portion corresponding to the teeth. An insulating film covers at least a portion of the laminated core corresponding to the teeth. A burr caused by the press working in each core sheet is located on a side of one end of the laminated core in a laminating direction of the laminated core. The burr of the teeth portion of one of the core sheets located at the one end is folded toward the other end of the laminated core in the laminating direction.

### CROSS REFERENCE TO RELATED APPLICATIONS

This application is based on and claims priority to Japanese Patent Applications No. 2010-224875 filed on Oct. 4, 2010 and No. 2011-024067 filed on Feb. 7, 2011, the contents of which are incorporated in their entirely herein by reference.

### FIELD OF THE INVENTION

The present invention relates to an armature for a rotary electric apparatus. The present invention further relates to a manufacturing method for the armature.

### BACKGROUND OF THE INVENTION

An armature of a conventional rotary electric apparatus includes a laminated core formed by laminating multiple core sheets and an insulating film covering the surface of the laminated core. In the present structure, the insulating film electrically insulates the laminated core from a winding wound around teeth of the armature.

FIG. 14 is a sectional view showing a section of teeth of an armature 80 according to a prior art. The section is along a laminating direction in which core sheets 82 of a laminated core 81 are laminated. Each of the core sheets 82 are formed by press working (punching). As shown in FIG. 14, the periphery of each of the core sheets 82 is bent backward when being punched to cause a burr 83 projected in the thickness direction. In the laminated core 81, the core sheets 82 are laminated such that the positions of the burrs 83 are arranged on the same upper side in FIG. 14 in the laminating direction. In the present state, the adjacent core sheets 82 are joined together to form the laminated core 81. In the present state, the burr 83 of the core sheet 82 located at one end on the upper side in FIG. 14 is projected upward in the laminating direction. Thus, the burr 83 is projected at the corner of the laminated core 81 in the laminating direction from the other end side toward the one end side. An insulating film 84 is formed by, for example, applying a powdery insulating material to the surface of the laminated core 81, heating the insulating material to melt the insulating material, and thereafter hardening the melted insulating material. When the insulating material is heated and melted, the insulating material is hardly accumulated around the corner portion of the laminated core 81 shown by the dashed line C in FIG. 14, compared with a flat portion. Thus, the melted insulating material is apt to flow out of the corner portion toward a peripheral portion around the corner portion. Therefore, the width of the insulating film is apt to be small and insufficient at the corner portion. The insulating film formed on the laminated core 81 needs a sufficient thickness to secure an electric insulation property also on the corner portion at which the insulating film is apt to be thin. However, as shown in FIG. 14, in the structure where the burr 83 projects upward from the corner portion of the laminated core 81, it is required to apply a larger amount of an insulating material by the projection height of the burr 83 to form a thicker insulating film. Consequently, the application of the insulating material requires higher manufacturing cost.

In consideration of this, according to another prior art as shown in FIG. 15, for example, core sheets 92 are laminated to form a laminated core 91, and thereafter, a high compression force is applied to the laminated core 91 in the laminating direction to manufacture an armature 90. In this way, the burr of a core sheet 92a located at the one end in the laminating direction is crushed and chamfered. In the present prior art, it is possible to restrain the burr of the core sheet 92a from projecting at the corner portion of the laminated core 91. Thus, application of an insulating material to form an insulating film 93 can be reduced.

For example, JP-U-7-44598 discloses a laminated core in which one core sheet located at one end in the laminating direction is reversed to face burr of the core sheet with bur of adjacent core sheet and laminated together. In the present art of JP-U-7-44598, the burr of the core sheet located at the one end in the laminating direction does not project outward in the laminating direction.

In the present art of JP-U-7-44598, application of high compression force is required to press the core sheet located at the one end of the laminated core onto the adjacent inner core sheet to squash the burr thereby to chamfer the corner of the laminated core. In addition, the pressing needs to be implemented until the chamfering is completed. Accordingly, the manufacturing method of JP-U-7-44598 requires an extended pressing process and an extended processing period. In addition, in the manufacturing method of the armature disclosed in JP-U-7-44598, an extra process for reversing the one core sheet is required.

### SUMMARY OF THE INVENTION

In view of the foregoing and other problems, it is an object of the present invention to produce an armature of a rotary electric apparatus, wherein a burr of a core sheet can be restricted from projecting at a corner of a laminated core, and an amount of an insulating material for forming an insulating film on the laminated core can be reduced. It is another object of the present invention to produce a manufacturing method of the armature of a rotary electric apparatus.

According to one aspect of the present invention, an armature for a rotary electric apparatus, the armature including teeth each configured to be equipped with a winding, the armature comprises a laminated core including a plurality of core sheets, which are laminated, and each being formed by press working, each of the plurality of core sheets having a teeth portion corresponding to the teeth. The armature further comprises an insulating film covering at least a portion of the laminated core corresponding to the teeth. A burr caused by the press working in each of the plurality of core sheets is located on a side of one end of the laminated core in a laminating direction of the laminated core. The burr of the teeth portion of one of the plurality of core sheets located at the one end is folded toward an other end of the laminated core in the laminating direction.

According to another aspect of the present invention, an armature for a rotary electric apparatus, the armature including teeth each configured to be equipped with a winding, the armature comprises a laminated core including a plurality of core sheets, which are laminated, and each being formed by press working, each of the plurality of core sheets having a teeth portion corresponding to the teeth. The armature further comprises an insulating film covering at least a portion of the laminated core corresponding to the teeth. A burr caused by the press working in each of the plurality of core sheets is located on a side of one end of the laminated core in a laminating direction of the laminated core. The burr of the teeth portion of one of the plurality of core sheets located at the one end of the laminated core is extended substantially in a direction perpendicular to the laminating direction. A width of the teeth portion of the one of the plurality of core sheets located at the one end is less than a width of the teeth portion of an other of the plurality of core sheets. A tip end of the burr of the teeth portion of the one of the plurality of core sheets is located inside a periphery of the teeth portion of the other of the plurality of core sheets when being viewed in a cross section taken along the laminating direction of the laminated core.

According to another aspect of the present invention, a manufacturing method for an armature for a rotary electric apparatus, the method comprises laminating a plurality of core sheets in a lamination process, each of the plurality of core sheets being formed by press working to have a teeth portion corresponding to teeth of the armature. The method further comprises pressing the plurality of core sheets in a laminating direction in a pressing process. The method further comprises forming an insulating film on the plurality of core sheets, which are laminated, in a film formation process. The plurality of core sheets are laminated in the lamination process such that a burr caused by the press working is located at a surface of each of the plurality of core sheets on a side of one end in the laminating direction. The burr of the teeth portion of one of the plurality of core sheets located at the one end is pressed in the pressing process such that the burr is folded toward an other end in the laminating direction.

According to another aspect of the present invention, a manufacturing method for an armature for a rotary electric apparatus, the method comprises laminating a plurality of core sheets in a lamination process, each of the plurality of core sheets being formed by press working to have a teeth portion corresponding to teeth of the armature. The method further comprises pressing the plurality of core sheets in a laminating direction in a pressing process. The method further comprises forming an insulating film on the plurality of core sheets, which are laminated, in a film formation process. The plurality of core sheets are laminated in the lamination process such that a burr caused by the press working is located at a surface of each of the plurality of core sheets on a side of one end in the laminating direction. The burr of the teeth portion of a first core sheet of the plurality of core sheets located at the one end in the laminating direction is pressed in the pressing process such that the burr is extended in a direction substantially perpendicular to the laminating direction. A width of the teeth portion of the first core sheet is less than a width of the teeth portion of a second core sheet of the plurality of core sheets, the second core sheet being adjacent to the first core sheet. A tip end of the burr of the teeth portion of the first core sheet is pressed to be located inside a periphery of the teeth portion of the second core sheet.

### BRIEF DESCRIPTION OF THE DRAWINGS

The above and other objects, features and advantages of the present invention will become more apparent from the following detailed description made with reference to the accompanying drawings. In the drawings:

FIG. 1 is a top view showing a state where a wire is wound around a rotor core according to the first embodiment;

FIG. 2 is a top view showing a rotor core according to the first embodiment;

FIG. 3 is a perspective view showing a laminated core according to the first embodiment;

FIG. 4 is a sectional view taken along the line IV-IV in FIG. 2;

FIG. 5 is a sectional view showing the laminated core in a lamination process in a manufacturing method for the rotor core according to the first embodiment;

FIG. 6 is a perspective view showing the laminated core in a pressing process in the manufacturing method for the rotor core according to the first embodiment;

FIG. 7 is a sectional view showing a teeth pressing portion of a pressing mechanism and a teeth portion of the laminated core in the pressing process in the manufacturing method for the rotor core according to the first embodiment;

FIG. 8 is a top view showing a rotor core according to the second embodiment;

FIGS. 9A, 9B are sectional views respectively taken along the line IXA-IXA and the line IXB-IXB in FIG. 8;

FIG. 10A is a graph showing the thickness of each of portions of an insulating film formed on the rotor core according to the second embodiment, and FIG. 10B is a graph showing the thickness of each of portions of an insulating film formed on a conventional rotor core according to a prior art;

FIG. 11 is a sectional view showing a portion of teeth of a rotor core according to the third embodiment;

FIG. 12 is a sectional view showing a teeth portion of a laminated core and a pressing mechanism for the rotor core according to the third embodiment;

FIG. 13 is a sectional view showing a portion of teeth of a rotor core according to another embodiment;

FIG. 14 is a sectional view showing teeth of a conventional armature according to the prior art;

FIG. 15 is a sectional view showing teeth of the conventional armature according to another prior art;

FIG. 16A is a partially sectional view showing a state where a stator core equipped with a winding according to another example, and FIG. 16B is a schematic view for explanation of the stator core and a segment winding according to another example; and

FIG. 17 is a sectional view showing a teeth pressing portion of a pressing mechanism according to another example and the teeth portion of the laminated core in the pressing process in the manufacturing method for the rotor core.

### DETAILED DESCRIPTION OF PREFERRED EMBODIMENTS

### First Embodiment

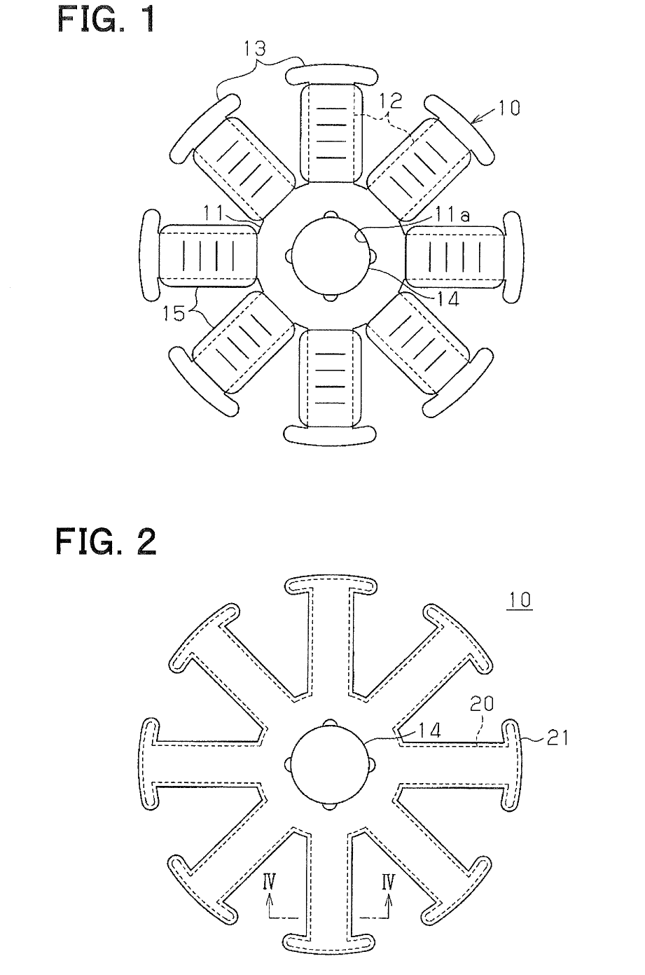

As follows, an armature of a rotary electric apparatus according to the first embodiment will be described with reference to FIGS. 1 to 7. In the present embodiment, the rotary electric apparatus includes a rotor core.

FIG. 1 shows the rotor core related to the present first embodiment. As shown in FIG. 1, the rotor core 10 includes a rotor center portion 11, eight teeth 12, and tip ends 13. The rotor center portion 11 is substantially in a circular shape on a planar view. The eight teeth 12 are radially extended from the rotor center portion 11. The tip ends 13 are respectively located at the ends of the teeth 12. Each of the tip ends 13 is substantially in an ellipse shape on a planar view. The rotor center portion 11 has an axial insertion hole 11a at the center. A rotation axis 14 is press-fitted in the axial insertion hole 11a. A winding 15 is wound on each of the teeth 12 in a winding direction perpendicular to a direction in which each tooth 12 are extended.

FIG. 2 is a planar view showing a state where the winding 15 is removed from the rotor core 10. The rotor core 10 includes a laminated core 20 and an insulating film 21 covering the surface of the laminated core 20.

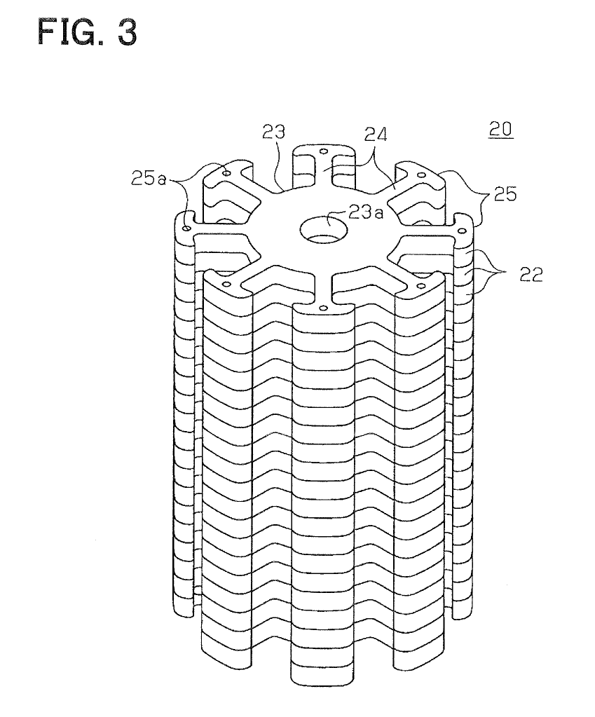

FIG. 3 is a perspective view showing the laminated core 20. As shown in FIG. 3, the laminated core 20 includes two or more core sheets 22 substantially in the same shape. The core sheets 22 are laminated together. In FIG. 3, the core sheets 22 are laminated in the vertical direction in the drawing to form the laminated core 20. In the following description, it is defined that one end side of a laminating direction is the upper side, and another-end side of the laminating direction is a lower side for convenience. It is noted that the description does not limit the laminating direction of the laminated core of the armature related to the present example.

Each core sheet 22 is formed by press working. Each core sheet 22 is in the shape corresponding to the shape of the rotor core 10. Each core sheet 22 includes a sheet center portion 23, teeth portions 24, and sheet tip ends 25. The sheet center portion 23 corresponds to the rotor center portion 11. The teeth portions 24 are radially extended from the center of the sheet center portion 23. The sheet tip ends 25 are respectively formed at the tip ends of the teeth portions 24. The sheet center portion 23 has a shaft hole 23a at the center. The shaft hole 23a extends through the core sheet 22. Each sheet tip end 25 has a fitting recess 25a on the upper surface and a fitting protrusion (not shown) on the lower surface on the backside of the upper surface. The core sheets 22 are adjacent to each other above and below in the laminated core 20. The fitting protrusion of the core sheet 22 on the upper side is fitted to the fitting recess 25a of the core sheet 22 on the lower side and thereby joint to each other. In this way, the multiple core sheets 22 are joined to each other.

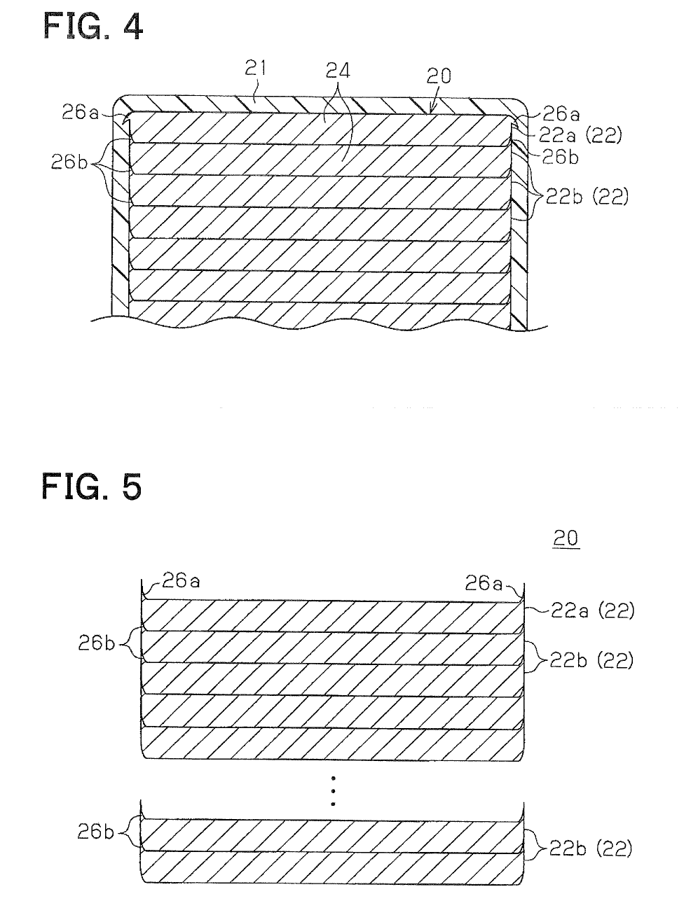

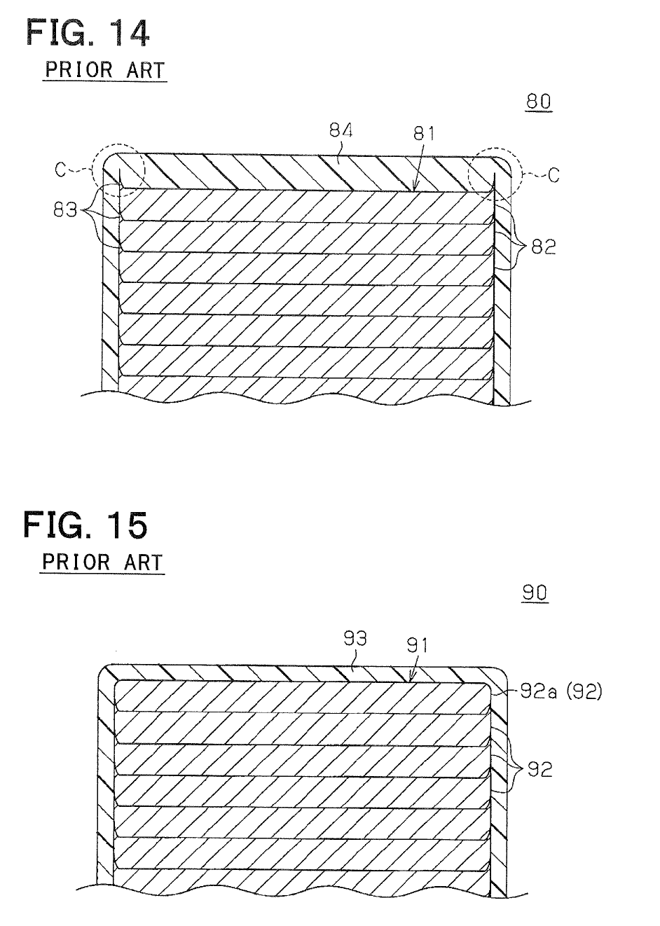

FIG. 4 is a sectional view taken along the line IV-IV in FIG. 2. As shown in FIG. 4, the multiple core sheets 22 are more specifically categorized into a first core sheet 22a and second core sheets 22b. The first core sheet 22a is located at the upper end of the laminated core 20 in the laminating direction. The second core sheets 22b are other than the first core sheet 22a. In the present embodiment, as shown in FIG. 4, all the core sheets 22a, 22b are laminated such that burrs 26a, 26b caused by press working are located correspondingly on the upper side of the core sheets 22a, 22b. In the first core sheet 22a, the burr 26a is bent downward and folded. The burr 26b of the second core sheet 22b extends upward. In the present structure, the burrs 26a, 26b of the core sheets 22a, 22b are located on the same upper side in the laminating direction. It is noted that the burr 26a of the first core sheet 22a is not projected upward. Therefore, it is not necessary to increase the film thickness of the insulating film 21 by the projection height of the burr in the rotor core 10 in order to secure the insulation property of the laminated core 20. Thus, in the present example, the thickness of the insulating film 21 is less than the thickness of the insulating film 84 shown in FIG. 14.

Subsequently, a manufacturing method for the rotor core 10 will be described with reference to FIGS. 5 to 7. In the manufacturing process of the rotor core 10, as shown in FIG. 5, a lamination process is first implemented to laminate the multiple core sheets 22a, 22b. As shown in FIG. 5, the first core sheet 22a and the second core sheets 22b are substantially in the same shape. The core sheets 22a, 22b are laminated such that the burrs 26a, 26b are located on the upper side. In the lamination process, the burrs 26a, 26b of the core sheets 22a, 22b are projected upward.

Subsequently, the laminated core sheets 22 are pressed in the laminating direction. Thereby, the fitting protrusion is fitted to the fitting recess 25a in the core sheets 22 adjacent to each other above and below. Thus, the core sheets 22 are joined together to form the laminated core 20.

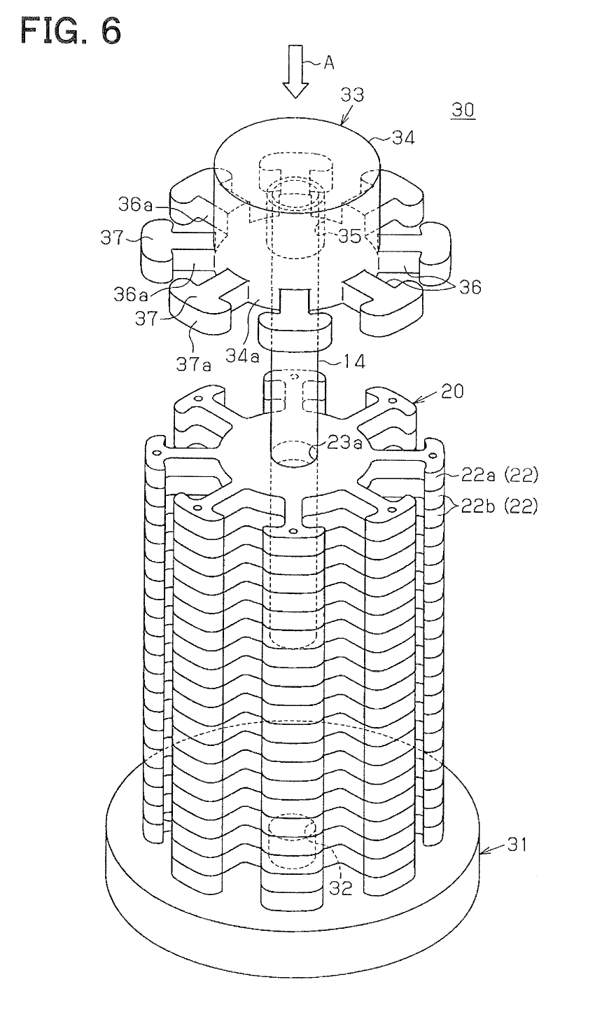

Subsequently, as shown in FIG. 6, a pressing process is implemented. In the pressing process, the rotation axis 14 is press-fitted into the shaft hole 23a of each of the core sheets 22 of the laminated core 20. In addition, the burr 26a of the first core sheet 22a in the state where its tip end extends upward as shown in FIG. 5 is folded to be in the state where the tip end extends downward as shown in FIG. 4.

As shown in FIG. 6, a pressing apparatus 30 is used to implement the pressing process. The pressing apparatus 30 includes a mounting base 31 and a pressing mechanism 33. The mounting base 31 receives and supports the laminated core 20. The pressing mechanism 33 compresses the laminated core 20. The mounting base 31 is in a circular shape on a planar view and is larger than the laminated core 20. The mounting base 31 has an axial support hole 32 at the center portion. The axial support hole 32 receives the rotation axis 14 being inserted therein and supports the rotation axis 14.

The pressing mechanism 33 is substantially in the same shape as that of the core sheets 22a, 22b and larger than the core sheets 22a, 22b on a planar view. The pressing mechanism 33 includes a center pressing portion 34, eight teeth pressing portions 36, and eight tip end pressing portions 37. The center pressing portion 34 is substantially in a column shape corresponding to the sheet center portions 23 of the core sheets 22a, 22b. The teeth pressing portions 36 are radially extended from a lower portion of the center pressing portion 34. The tip end pressing portions 37 are respectively provided at tip ends of the teeth pressing portions 36. The center pressing portion 34 has an axis holding hole 35 at the lower surface for supporting the rotation axis 14. The center pressing portion 34, the teeth pressing portions 36, and the tip end pressing portions 37 respectively have burr bending portions 34a, 36a, 37a at the lower ends. The burr bending portions 34a, 36a, 37a are extended downward respectively from the peripheries of the center pressing portion 34, the teeth pressing portions 36, and the tip end pressing portions 37.

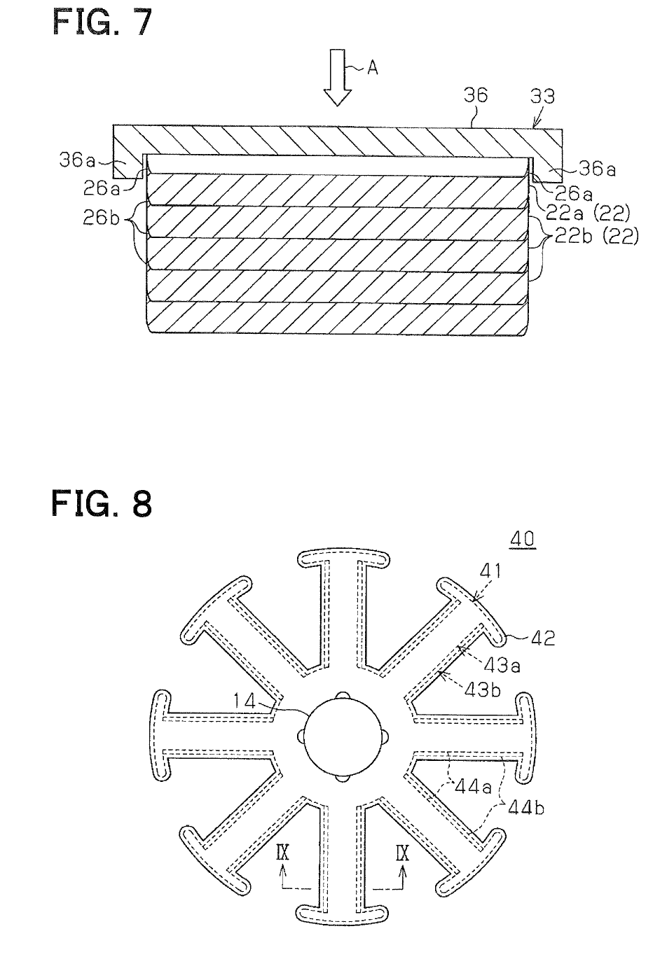

In FIG. 6, the rotation axis 14 is supported by the center pressing portion 34. In the present state, the pressing mechanism 33 is pressed downward in the direction shown by the arrow A to press-insert the rotation axis 14 into the shaft holes 23a of the core sheets 22a, 22b of a laminated core 41. The pressing mechanism 33 in the state shown in FIG. 6 is further pressed in the direction shown by the arrow A. Thus, the pressing mechanism 33 makes contact with the upper surface of the first core sheet 22a of the laminated core 20. Thus, as shown in FIG. 7, the pressing mechanism 33 is in contact with the upper surface of the first core sheet 22a. In the present state, the lateral side of the first core sheet 22a is surrounded by the burr bending portions 34a, 36a, 37a of the pressing mechanism 33. In the present state, the pressing mechanism 33 is further pressed in the direction shown by the arrow A, thereby to press-fit the rotation axis 14 into the shaft hole 23a of each core sheet 22 of the laminated core 20. Thus, the rotation axis 14 is fixed to the laminated core 20. In addition, the burr 26a located around the periphery of the first core sheet 22a and initially extended upward is folded to be directed downward as shown in FIG. 4.

Thereafter, the laminated core 20 is removed from the pressing apparatus 30. Subsequently, a film formation process is implemented to form an insulating film 21 on the surface of the laminated core 20. In the film formation process, a powdery insulating material is first applied to the surface of the laminated core 20. Subsequently, the applied insulating material is heated and melted. Thus, the insulating material is hardened. In the present embodiment, the burr 26a of the first core sheet 22a is folded downward. That is, the burr 26a is redirected so as not to be projected upward. Therefore, the amount of applications of the insulating material for securing the insulation property of the laminated core 20 can be reduced, compared with the structure in which the burr is projected upward. Thus, the insulating film 21 is formed on the surface of the laminated core 20, and consequently, the rotor core 10 is manufactured.

According to the above structure and method, the following operation effects are produced.

(1) The insulating film 21 is formed on the surface of the laminated core 20 in the rotor core 10 according to the present embodiment. The core sheets 22a, 22b are formed by press working, and subsequently, the core sheets 22a, 22b are laminated in the vertical direction to construct the laminated core 20, such that the burrs 26a, 26b of the core sheets 22a, 22b are located on the upper side. Ultimately, the burr 26a of the first core sheet 22a located at the upper end is folded downward toward the second core sheet 22b. In this way, the burr 26a of the first core sheet 22a located at the upper end can be restricted from being projected upward. As described above, the burr 26a of the first core sheet 22a is folded. In the present structure, the burr 26a may be slightly projected radially in the horizontal direction of the laminated core 20. That is, the burr 26a may be slightly projected perpendicularly to the laminating direction of the laminated core 20. Nevertheless, the projection of the burr 26a in the horizontal direction is still restricted small, since the tip end of the burr 26a is folded downward. With this relatively simple method, by folding the burr 26a of the first core sheet 22a located at the upper end of the laminated core 20, it is possible to restrain the burr 26a from being projected outward from the periphery (corner) of the laminated core 20. Therefore, the amount of applications of the insulating material for forming the insulating film 21 can be reduced in the above-described method differently from conventional one.

(2) The process for press-fitting the rotation axis 14 into the shaft hole 23a of the laminated core 20 including the laminated core sheets 22a, 22b and the process for pressing to deform the burr 26a of the first core sheet 22a can be simultaneously implemented in the pressing process to manufacture the rotor core 10 according to the present embodiment. Therefore, the process for press-fitting the rotation axis 14 and the process for deforming the burr 26a need not be individually implemented. Thus, the manufacturing process can be simplified.

### Second Embodiment

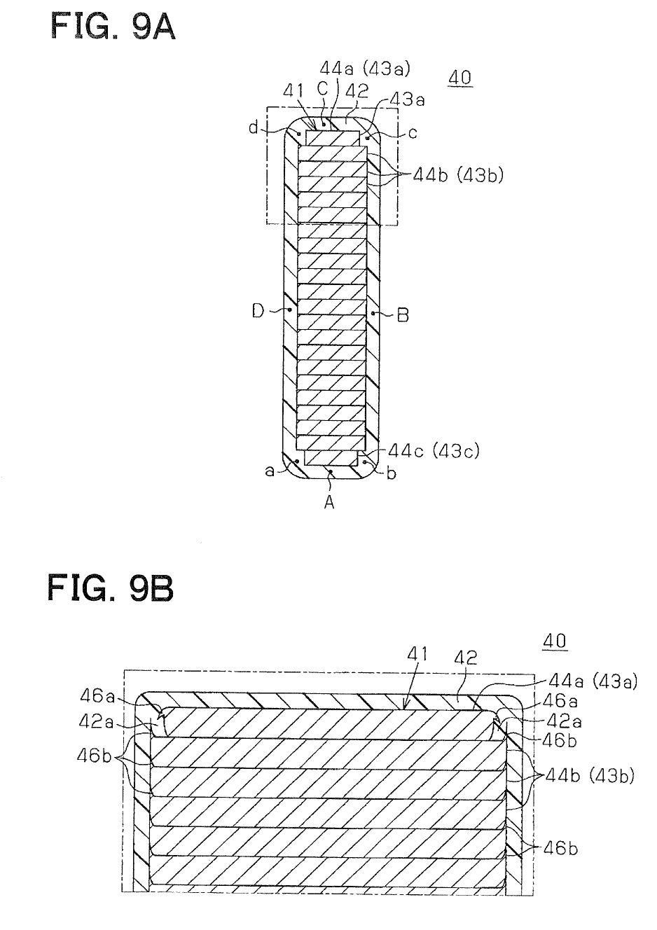

Subsequently, the rotor core according to the second embodiment will be described with reference to FIGS. 8 to 10B. As shown in FIG. 8, an insulating film 42 is formed on the surface of the laminated core 41 of a rotor core 40 according to the present embodiment. As shown in FIGS. 8, 9A, 9B, the laminated core 41 includes a first core sheet 43a being a single sheet, multiple second core sheets 43b, and a third core sheet 43c being a single sheet. The first core sheet 43a, the second core sheets 43b, and the third core sheet 43c are laminated.

As shown in FIGS. 8, 9A, 9B, each teeth portion 44a of the first core sheet 43a has the width in the direction perpendicular to the extended direction in which the teeth portion 44a is extended. That is, each teeth portion 44a has the width in the horizontal direction on FIGS. 9A, 9B. The width of each teeth portion 44a of the first core sheet 43a is less than the width of each teeth portion 44b of the second core sheet 43b. The periphery of the teeth portion 44a of the first core sheet 43a is located inside the periphery of the teeth portion 44b of the second core sheet 43b. As shown in FIG. 9A, each teeth portion 44c of the third core sheet 43c has the width same as the width of the teeth portion 44a of the first core sheet 43a. The periphery of the teeth portion 44c of the third core sheet 43c is located inside the periphery of the teeth portion 44b of the second core sheet 43b.

In the present structure of the laminated core 41, the width of the teeth portions 44a, 44c of the first core sheet 43a and the third core sheet 43c located at the both ends in the laminating direction are less than the width of the teeth portion 44b of the second core sheet 43b. In addition, the teeth portions 44a, 44c of the first core sheet 43a and the third core sheet 43c are located inside the teeth portion 44b of the second core sheet 43b in the direction perpendicular to the laminating direction. In the present embodiment, the insulating film 42 is formed on the surface of the laminated core 41 in such a shape. Therefore, the corner of the teeth of the rotor core 40 is in a round shape (R-shape).

FIG. 9B is an enlarged view showing the region indicated by the dashed dotted line in FIG. 9A. As shown in FIG. 9B, in the teeth portion 44a of the first core sheet 43a, the tip end of a burr 46a is folded to be extended downward, similarly to the first embodiment. In the teeth portion 44a of the first core sheet 43a, the burr 46a is folded. In the present structure, the burr 46a is slightly projected in the horizontal direction. Nevertheless, the burr 46a is still located inside the periphery of the teeth portion 44b of the second core sheet 43b. In addition, a portion 42a of the insulating film 42 corresponding to (close to) the corner of the laminated core 41 is interposed between the burr 46a of the first core sheet 43a and a burr 46b of the second core sheet 43b adjacent to the first core sheet 43a.

The laminated core 41 is manufactured substantially in the same method as that of the first embodiment. Specifically, the lamination process is first implemented to laminate the first core sheet 43a, the multiple second core sheets 43b, and the third core sheet 43c, such that the third core sheet 43c and the first core sheet 43a are located at both the ends of the laminated core 41. Subsequently, the pressing process is implemented to press-fit the rotation axis 14 into the laminated core 41 and simultaneously to fold the burr 46a of the first core sheet 43a such that the tip end of the burr 46a is extended downward, as shown in FIG. 9B. The shape of the pressing mechanism used in the pressing process is determined to correspond to the shape of the first core sheet 43a. Thereafter, the powdery insulating material is applied to (painted on) the surface of the laminated core 41. Subsequently, the applied insulating material is heated and hardened. In this way, the film formation process is implemented to form the insulating film 42.

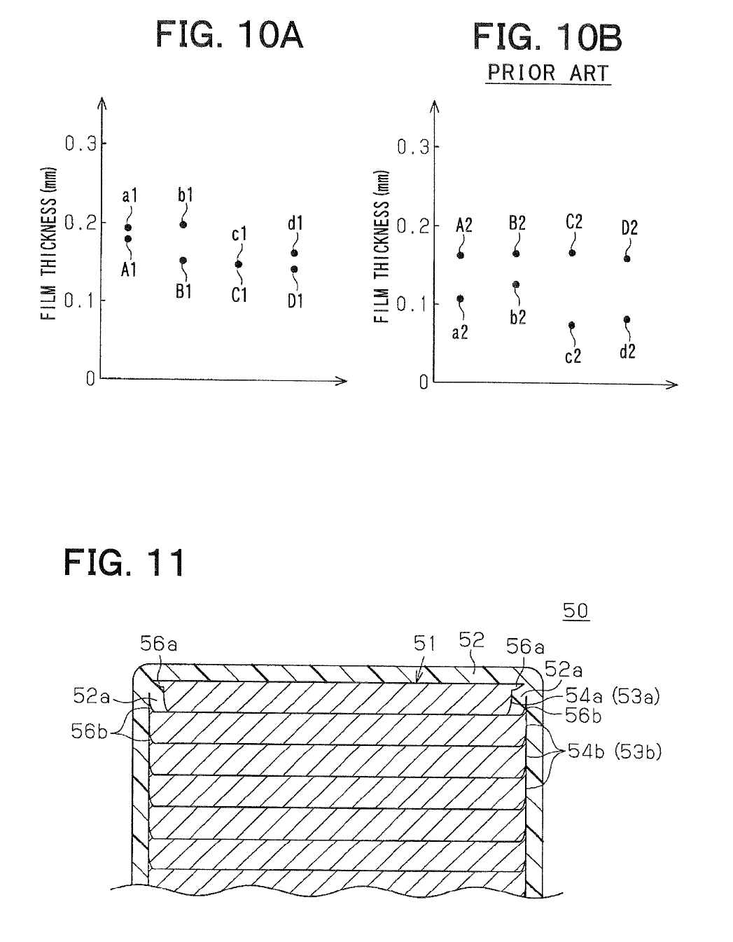

FIG. 10A is a graph showing the film thickness of each of different portions of the insulating film 42 of the rotor core 40 according to the present embodiment. In FIG. 10A, the notations A1, B1, C1, D1 respectively demote the values of the thickness of the portions A, B, C, D of the insulating film 42 formed on the flat surfaces of the laminated core 41 shown in FIG. 9A. In FIG. 10A, the notations a1, b1, c1, d1 respectively denote the values of the thickness of the insulating film 42 formed on the corners a, b, c, d of the laminated core 41 shown in FIG. 9A. FIG. 10B shows the values of the thickness of the insulating film formed on the laminated core 81 shown in FIG. 14 according to the prior art. In FIG. 10B, the notations A2, B2, C2, D2 respectively demote the values of the thickness of the insulating film formed on the flat surfaces of the laminated core 81, and the notations a2, b2, c2, d2 respectively denote the values of the thickness of the insulating film formed on the corners of the laminated core 81.

In the present embodiment, as denoted by A1 to D1 in FIG. 10A, the values of the thickness of the insulating film 42 on the corresponding flat portions of the laminated core 41 is about 0.15 mm. In addition, as denoted by a1 to d1 , the values of the thickness of the insulating film 42 on the corresponding corner portions of the laminated core 41 is about 0.15 to 0.2 mm. Thus, in the present embodiment, the thickness of the insulating film 42 on the corner portions of the laminated core 41 is equivalent to or more than the thickness of the flat portions. In the conventional laminated core 81 according to the prior art, as denoted by A2 to D2 in FIG. 10B, the thickness of the flat portions of the insulating film 84 on the laminated core 81 is set at about 0.15 mm. In the prior art contrary to the present embodiment, as denoted by a2 to d2 in FIG. 10B, the thickness of the corresponding corner portions of the insulating film becomes about 0.75 to 0.1 mm. That is, the thickness of the corresponding corner portions of the insulating film is about half of that thickness of the flat portions of the insulating film 84 according to the prior art. In consideration of the problem, in the laminated core 81 shown in FIG. 14, the insulating material needs to be applied by a large amount to form a thick layer in order to secure a sufficient thickness of the insulating film on the corner portions, as described above. To the contrary, in the present second embodiment, even in the corner portions, the thickness of the insulating film 42 formed on the laminated core 41 can be secured to be greater than or equal to the thickness of the insulating film 42 formed on the flat portions of the laminated core 41.

In the present embodiment, the thickness of the portions of the insulating film 42 corresponding to the corners of the laminated core 41 is larger than the thickness of the insulating film 42 on the flat portions of the laminated core 41 in this way. Nevertheless, the amount of insulating material for forming the insulating film 42 can be reduced to 60% of the amount of the prior art. Consequently, a processing time required for application of the insulating material can be reduced to 50% of the processing time of the prior art.

According to the second embodiment described above in detail, the following operation effects (3) to (5) can be produced in addition to the operation effects (1), (2) of the first embodiment.

(3) In the present embodiment, the teeth portion 44a of the first core sheet 43a is formed to be less than the teeth portion 44b of the second core sheet 43b in width. Therefore, in the end of the laminated core 41 as shown in FIG. 9, the periphery of the teeth portion 44a of the first core sheet 43a is located inside the periphery of the teeth portion 44b of the second core sheet 43b. In the present structure, the burr 46a on the teeth portion 44a of the first core sheet 43a is folded, and consequently, the burr 46a may be slightly projected in the horizontal direction of the laminated core 41 perpendicularly to the laminating direction. Nevertheless, it is possible to restrain the folded burr 46a from projecting beyond other portions of the laminated core 41 in the horizontal direction of the laminated core 41. Therefore, the thickness of the insulating film 42 can be secured on the corner portions, while an amount of application of the insulating material for forming the insulating film 42 is reduced.

(4) In the present embodiment, the burr 46a of the first core sheet 43a and the burr 46b of the adjacent second core sheet 43b can interpose the portions of the insulating film 42 corresponding to the corners of the laminated core 41 therebetween. Therefore, the laminated core 41 can firmly support the insulating film 42. Thus, it is possible to restrain the insulating film 42 from exfoliating from the surface of the laminated core 41.

(5) According to the present embodiment, the teeth portion 44a of the first core sheet 43a is located inside the teeth portion 44b of the second core sheet 43b. Therefore, in the state where the insulating film 42 is formed on the laminated core 41, the corner portions of the teeth of the rotor core 40 is in round shapes. Therefore, when a wire is wound around the teeth of the rotor core 40, it is possible to restrain the wire being wound from being stacked on the corner portions. Therefore, it is possible to restrict the insulating film 42 on the corner portions of the teeth from exfoliating due to such stack of the wire on the corner portions. In addition, the corner portions of the rotor core 40 are in round shapes. Therefore, swelling of the wire wound around the corner portions of the teeth can also be reduced.

### Third Embodiment

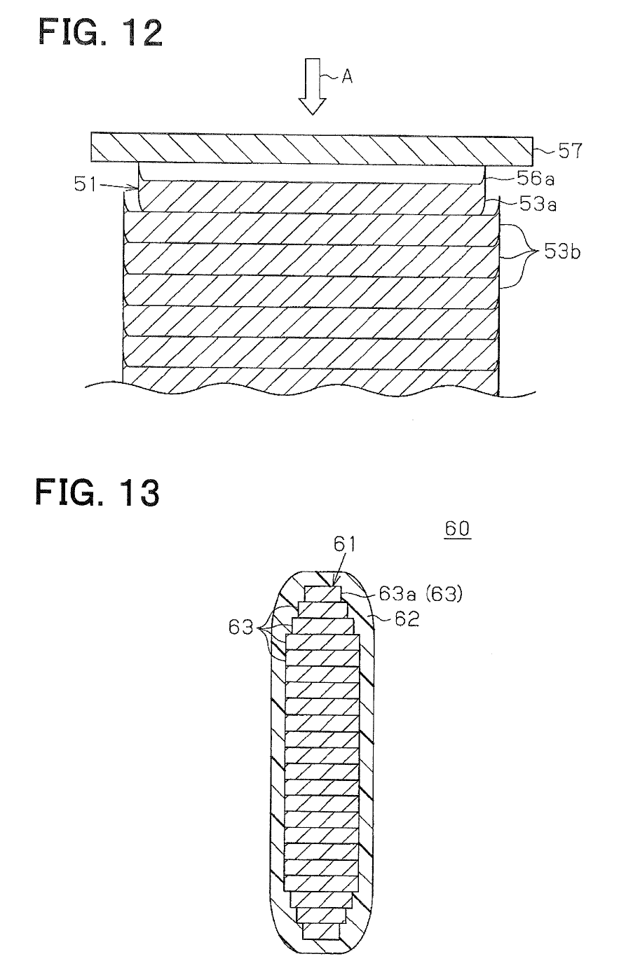

Subsequently, the rotor core according to the third embodiment will be described with reference to FIGS. 11, 12. As shown in FIG. 11, an insulating film 52 is formed on the surface of a laminated core 51 of a rotor core 50 according to the present embodiment. The laminated core 51 includes a first core sheet 53a, a second core sheets 53b, and a third core sheet (not shown) being laminated. In the present embodiment, the structure of the laminated core other than the shape of a burr 56a of the first core sheet 53a is substantially equivalent to that of the second embodiment.

Specifically, in present embodiment as shown in FIG. 11, the burr 56a of a teeth portion 54a of the first core sheet 53a extends in the horizontal direction in FIG. 11 perpendicularly to the laminating direction of the core sheets 53a, 53b. In the present structure of the first core sheet 53a, the burr 56a extends in the horizontal direction, and consequently, the burr 56a projects in the horizontal direction. Nevertheless, the tip end of the burr 56a is still located inside the periphery of a teeth portion 54b of the second core sheet 53b. In addition, a portion 52a of the insulating film 52 corresponding to (close to) the corner portion of the laminated core 51 is interposed between the burr 56a of the first core sheet 53a and a burr 56b of the second core sheet 53b adjacent to the first core sheet 53a.

The laminated core 51 is manufactured substantially in the same method as those of the above embodiments. Specifically, the lamination process is first implemented to laminate the first core sheet 53a, the second core sheets 53b, and the third core sheet. Subsequently, the pressing process is implemented to press-fit the rotation axis into the laminated core 51. It is noted that, in the present embodiment dissimilarly to the above embodiments, the shape of a pressing mechanism 57 of the pressing apparatus used in the pressing process differs from those of the above embodiments. Specifically, the lower end of the pressing mechanism 57 is in a flat shape. That is, the periphery of the pressing mechanism 57 does not extend downward. As shown in FIG. 12, the pressing mechanism 57 according to the present embodiment is pressed in the direction shown by the arrow A. Thereby, as shown in FIG. 11, the burr 56a of the first core sheet 53a is bent and extended in the direction perpendicular to the laminating direction of the core sheets 53a, 53b of the laminated core 51. Thereafter, the powdery insulating material is applied to (painted on) the surface of the laminated core 51. Subsequently, the applied insulating material is heated and hardened. In this way, the film formation process is implemented to form the insulating film 52.

According to the third embodiment described above in detail, the following operation effect (6) can be produced in addition to the operation effect (2) of the first embodiment and operation effects (4), (5) of the second embodiment, similarly.

(6) In the rotor core 50 according to the present embodiment, the laminated core 51 includes the core sheets 53a, 53b laminated above and below such that the burrs 56a, 56b are located on the upper side. In the first core sheet 53a located at the upper end, the burr 56a is extended in the horizontal direction perpendicular to the laminating direction. In this way, the burr 56a of the first core sheet 53a located at the upper end of the laminated core 51 can be restricted from being projected upward from the laminated core 51.

In the present structure, the burr 56a is extended from the teeth portion 54a of the first core sheet 53a in the direction perpendicular to the laminating direction. Nevertheless, the tip end of the burr 56a is still located inside the periphery of the teeth portion 54b of the second core sheet 53b. Therefore, in the laminated core 51 according to the present embodiment, it is possible to restrain the tip end of the burr 56a of the first core sheet 53a from projecting in the horizontal direction beyond the periphery of the teeth portion 54b of the second core sheet 53b.

With this relatively simple method, by bending the burr 56a of the first core sheet 53a located at the upper end of the laminated core 51, it is possible to restrain the burr 56a from being projected outward from the periphery (corner) of the laminated core 50. Therefore, the amount of applications of the insulating material for forming the insulating film 52 can be reduced in the above-described method differently from conventional one.

### Other Embodiments

In the above embodiments, the insulating film is formed in the entire surface of the laminated core. It is noted that the insulating film may be formed only on a teeth portion and/or only on a portion around the teeth portion. Even in such cases, the laminated core of the rotor core can be insulated from the wire wound around the teeth of the rotor core.

In the second and third embodiments, the width of both the teeth portions of the first core sheet and the third core sheet are less than the width of the teeth portion of the second core. It is noted that, not only the teeth portion, but the first core sheet and/or the third core sheet may be entirely smaller than the second core sheet. Specifically, the sheet center portion and the sheet tip ends of the first core sheet and/or the third core sheet may be respectively smaller than the sheet center portion and the sheet tip ends of the second core sheet.

In the second and third embodiments, the width of the teeth portions of only the core sheets located at both the ends of the laminated core is less than the width of the teeth portion of a center portion of the laminated core excluding both the ends. It is noted that, as shown in FIG. 13, a rotor core 60 including a laminated core 61 having the surface formed with an insulating film 62 may have the following structure. Specifically, the width of the teeth portion gradually decreases in a core sheet 63 toward both the ends of the laminated core 61. In the present structure, the periphery of one core sheet 63 is located inside the periphery of the other adjacent core sheet 63 on the center side. In the present structure, the tip end of the burr of a core sheet 63a of the laminated core 61 located at the one end in the laminating direction may be folded and redirected to extend from the one end toward the other end in the laminating direction. Alternatively, the tip end of the burr of the core sheet 63a may be deformed and extended in the direction perpendicular to the laminating direction.

In the second and third embodiments, the width of the teeth portions of the core sheets at both the ends of the laminated core is less than the width of the teeth portions of the core sheets located midway in the laminating direction. It is noted that, among the core sheets, the teeth portion of only a core sheet on one end side on which a burr projects outward may have the smaller width.

In the above embodiments, the process for press-fitting the rotation axis into the laminated core of the rotor core and the process for pressing to deform the burr of the core sheet located at the one end of the laminated core are simultaneously implemented. It is noted that the process for press-fitting the rotation axis and the process for deforming the burr of the core sheet may be separately implemented. The burr of the core sheet located at one end may be deformed simultaneously with the process for pressing to fit the fitting protrusion of the core sheet into the fitting recess of the adjacent core sheet in manufacturing of the laminated core of the rotor core.

In the above embodiments, the above-noted structures and methods are applied to the armature of the rotary electric apparatus including the rotor core. It is noted that the above-noted structures and methods may be applied to an armature of a rotary electric apparatus including a stator core.

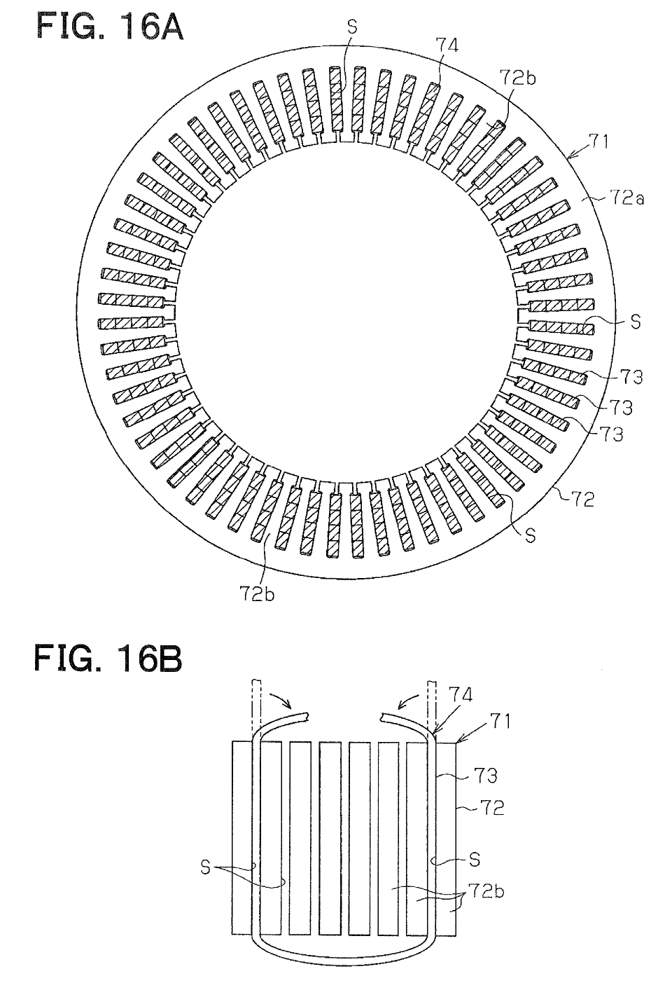

For example, the above-noted structures and methods may be applied to a stator of an armature of a rotary electric apparatus shown in FIG. 16. In the example of FIG. 16, an inner rotor type brushless motor includes the armature including a stator core 71. More specifically, as shown in FIG. 16A, the stator core 71 includes a laminated core 72 including a tubular portion 72a and multiple teeth 72b. The teeth 72b are arranged in the circumferential direction to extend from the cylinder portion 72a toward the radially inner side. In the present example, the number of the teeth 72b is 60. The adjacent teeth 72b define a slot S therebetween. As schematically shown in FIG. 16B, one of multiple segment conductors 73 is inserted into the slots S in the axial direction. Each of the segment conductors 73 is formed by bending a conductor plate in the shape of a U-character. In FIG. 16B, one of the segment conductors 73 is illustrated. Subsequently, for example, ends of the segment conductors 73 inserted in different slots S to extend therethrough are bent in the direction shown by the two-dot chain lines and arrows in FIG. 16B to be in contact with each other. Thus, different segment conductors 73 are electrically connected to be a segment winding 74. The structures of the above embodiments and/or the manufacturing method of the above embodiments may be applied to the teeth 72b equipped with the segment winding 74 (winding) in this way. FIGS. 16A, 16B are for describing a different type of an armature, and illustration of an insulating film and the like are omitted in FIGS. 16A, 16B, Similar operation effects to those in the above-noted embodiments may be produced by applying the above-noted structures and the above-noted manufacturing methods to the armature.

Summarizing the above embodiments, an armature for a rotary electric apparatus, the armature including teeth equipped with a winding, the armature includes a laminated core including multiple laminated core sheets each formed by press working; and an insulating film covering at least a portion of the laminated core corresponding to the teeth. Each of the core sheets has a burr caused by the press working and located on one end side in a laminating direction of the laminated core. In one of the core sheets located at one end of the laminated core in the laminating direction, the burr in a teeth portion corresponding to the teeth is folded toward the other end side in the laminating direction. In the present structure, the burr of the core sheet located at the one end in the laminating direction of the laminated core is folded to the inside of the laminated core. Therefore, it is possible to restrain the burr from projecting to the outside at the corner of the laminated core. The burr of the core sheet located at the one end is folded, and thereby, the burr may be projected slightly in the direction perpendicular to the laminating direction of the laminated core. Nevertheless, the tip end of the burr is folded and extended toward the other core sheet. That is, the tip end of the burr does not extend perpendicularly to the laminating direction. Therefore, the burr is restrained from being projected largely in the direction perpendicular to the laminating direction.

The burr of the teeth portion of the core sheet located at the one end in the laminating direction is bent in this way. Thereby, the burr can be restrained from being projected outward from the corner of the laminated core. Thus, without application of high load on the laminated core in order to chamfer the burr at the corner and without turning over the core sheet located at one end, an amount of application of the insulating material for forming the insulating film can be reduced in the method different from a conventional way.

The winding may be wound around the teeth. In the present structure, the above-described operation effect can be produced for the winding wound around the teeth.

The winding may be a segment winding including multiple segment conductors inserted into a slot between the teeth in the axial direction and electrically connected with each other. In the present structure, the above-described operation effect can be produced for the winding being the segment winding including the multiple segment conductors each inserted into the slot between the teeth in the axial direction and electrically connected with each other.

In the core sheet located at the one end, the width of the teeth portion may be formed to be less than the width of the teeth portion of other core sheets. In this case, when being viewed in a cross section taken along the laminating direction of the laminated core, the burr of the teeth portion may be located inside a periphery of the teeth portion of the other core sheets.

In the present structure, the burr of the teeth portion of the core sheet located at the one end in the laminating direction is folded. Therefore, the burr may be projected slightly in the direction perpendicular to the laminating direction of the laminated core. Nevertheless, the burr is located still inside the periphery of the teeth portion of the other core sheets. Therefore, the burr being folded can be restrained from projecting beyond the other portion in the direction perpendicular to the laminating direction of the laminated core.

Further, in the present structure, the burr of the core sheet located at the one end in the laminated core and the burr of the adjacent core sheet interpose a portion of the insulating film corresponding to the corner of the laminated core therebetween. Therefore, the laminated core supports the insulating film further firmly between the adjacent burrs to restrict the insulating film from exfoliating off the laminated core.

Further, in the present structure, the burr of the teeth portion of the core sheet located at the one end is located inside the teeth portion of the other core sheets. Therefore, the insulating film formed on the laminated core is in a round shape at the corner of the teeth of the armature. Therefore, when a wire is wound around the teeth of the rotor core, it is possible to restrain the wire being wound from being stacked on the corner portions. Therefore, it is possible to restrict the insulating film on the corner portions of the teeth from exfoliating due to such stack of the wire on the corner portions. In addition, the corner of the teeth of the armature is in a round shape, as described above. Therefore, when the wire is wound around the teeth, for example, the winding can be easily formed to be closely in contact with the corner of teeth, compared with teeth each being in an edged shape. Thus, swelling of the winding at the corner can also be reduced.

An armature for a rotary electric apparatus including teeth equipped with a winding, includes: a laminated core including multiple laminated core sheets each formed by press working; and an insulating film covering at least a portion of the laminated core corresponding to the teeth. In each of the core sheets, a burr caused by the press working is located on one end side in a laminating direction of a laminated core. In the core sheet located at one end of the laminated core in the laminating direction, the burr of a teeth portion corresponding to the teeth is extended substantially in a direction perpendicular to the laminating direction. A width of the teeth portion is formed to be less than a width of the teeth portion of the other core sheets. When being viewed in a cross section taken along the laminating direction of the laminated core, a tip end of the burr of the teeth portion is located inside a periphery of the teeth portion of the other core sheets.

In the present structure, the burr of the core sheet located at the one end in the laminating direction of the laminated core is restricted from extending in a direction from the other tip end of the laminated core in the laminating direction to the one end of the laminated core in the laminating direction. Therefore, it is possible to restrain the burr from projecting outward in the laminating direction at the corner of the laminated core. The burr may be extended in the direction perpendicular to the laminating direction at the teeth portion of the core sheet located at the one end. Nevertheless, the tip end of the burr is still located inside the periphery of the teeth portion of the other core sheets. Therefore, the burr of the core sheet located at the one end of the laminated core can be restricted from projecting in the direction perpendicular to the laminating direction beyond the other portion of the laminated core.

Therefore, the burr located at the one end in the laminating direction can be restrained from projecting beyond the other portion. Therefore, an amount of applications of the insulating material for forming the insulating film can be reduced.

Further, in the present structure, the burr of the core sheet located at the one end in the laminated core and the burr of the adjacent core sheet interpose a portion of the insulating film corresponding to the corner of the laminated core therebetween. Therefore, the laminated core supports the insulating film further firmly between the adjacent burrs to restrict the insulating film from exfoliating from the laminated core.

Further, in the present structure, the burr of the teeth portion of the core sheet located at the one end is located inside the teeth portion of the other core sheets. Therefore, the insulating film formed on the laminated core is in a round shape at the corner of the teeth of the armature. Therefore, when a wire is wound around the teeth of the rotor core, it is possible to restrain the wire being wound from being stacked on the corner portions. Therefore, it is possible to restrict the insulating film on the corner portions of the teeth from exfoliating due to such stack of the wire on the corner portions. In addition, the corner of the teeth of the armature is in a round shape, as described above. Therefore, when the wire is wound around the teeth, for example, the winding can be easily formed to be closely in contact with the corner of teeth, compared with teeth each being in an edged shape. Thus, swelling of the winding at the corner can also be reduced.

A manufacturing method for an armature for a rotary electric apparatus, the method includes: laminating multiple core sheets, each of which is formed by press working, in a lamination process; pressing the multiple core sheets in a laminating direction in a pressing process; and forming an insulating film on the laminated core sheet in a film formation process. The multiple core sheets are laminated in the lamination process such that the burr caused by the press working is located in a surface of the multiple core sheets on one end side in the laminating direction. The burr of a teeth portion corresponding to teeth of the armature in the core sheet located at one end in the laminating direction is pressed in the pressing process such that the burr is folded to the other end side in the laminating direction.

According to the present method, the burr of the teeth portion of the core sheet located at the one end of the multiple core sheets in the laminating direction is folded toward the other core sheet to produce the armature. Therefore, it is possible to restrain the burr from projecting outward at the corner of the laminated core thereby to restrain applications of the insulating material from increasing, in the present method different from conventional one.

A manufacturing method for an armature for a rotary electric apparatus, the method includes: laminating multiple core sheets, each of which is formed by press working, in a lamination process; pressing the multiple core sheets in a laminating direction in a pressing process; and forming an insulating film on the laminated core sheet in a film formation process. The multiple core sheets are laminated in the lamination process such that the burr caused by the press working is located in a surface of the multiple core sheets on one end side in the laminating direction. The burr of a teeth portion corresponding to teeth of the armature in a first core sheet located at one end in the laminating direction is pressed in the pressing process such that the burr extends in a direction perpendicular to the laminating direction. A width of the teeth portion of the first core sheet corresponding to the teeth of the armature is less than a width of the teeth portion of an adjacent second core sheet. A tip end of the burr is pressed to be located inside a periphery of the teeth portion of the second core sheet.

In the present method, the burr of the teeth portion of the first core sheet is pressed and extended in the direction perpendicular to the laminating direction of the laminated core to produce the armature. Therefore, it is possible to restrain the burr from projecting outward at the corner of the laminated core thereby to restrain applications of the insulating material from increasing, in the present method different from conventional one.

The armature includes a rotor core. Each of the core sheet includes a sheet center portion having a shaft hole and multiple teeth portions radially extended from the sheet center portion. A rotation axis is press-fitted in the shaft hole of the laminated core sheet in the pressing process.

According to the present configuration, the process for press-fitting the rotation axis into the laminated core sheet and the process for pressing to deform the burr of the core sheet located on the one end side in the laminating direction can be implemented simultaneously. Therefore, the pressing process for press-fitting the rotation axis and the process for deforming the burr need not be individually implemented. Thus, the manufacturing process can be simplified.

Therefore, the burr located at the corner portion of the laminated core can be restrained from projecting in the present method different from conventional one. Therefore, an amount of applications of the insulating material for forming the insulating film can be reduced.

### Other Embodiment

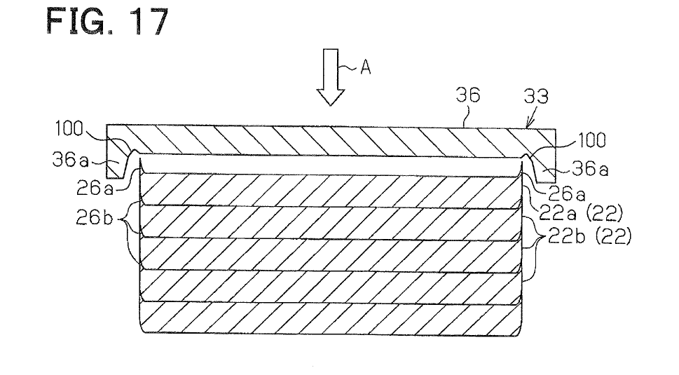

The configuration shown in FIG. 17 may be employed to form a corner portion 100 in the burr bending portion 36a thereby to easily release the burr 26a radially outward.

The multiple teeth portions 44 in the above embodiments may be denoted by a single teeth portion 44. The above structures of the embodiments can be combined as appropriate.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An armature for a rotary electric apparatus, the armature including teeth each configured to be equipped with a winding, the armature comprising:
a laminated core including a plurality of core sheets, which are laminated, and each being formed by press working, each of the plurality of core sheets having a teeth portion corresponding to the teeth; and
an insulating film covering at least a portion of the laminated core corresponding to the teeth, wherein
a burr caused by the press working in each of the plurality of core sheets is located on a side of one end of the laminated core in a laminating direction of the laminated core, and
the burr of the teeth portion of one of the plurality of core sheets located at the one end is folded toward an other end of the laminated core in the laminating direction.

2. The armature according to claim 1, wherein the winding is wound on each of the teeth.

3. The armature according to claim 1, wherein
the winding is a segment winding including a plurality of segment conductors respectively inserted in an axial direction into slots, each of which is formed between the teeth, and
the plurality of segment conductors are electrically connected with each other.

4. The armature according to claim 1, wherein
a width of the teeth portion of the one of the plurality of core sheets located at the one end is less than a width of the teeth portion of an other of the plurality of core sheets, and
the burr of the teeth portion of the one of the plurality of core sheets is located inside a periphery of the teeth portion of the other of the plurality of core sheets when being viewed in a cross section taken along the laminating direction of the laminated core.

5. An armature for a rotary electric apparatus, the armature including teeth each configured to be equipped with a winding, the armature comprising:
a laminated core including a plurality of core sheets, which are laminated, and each being formed by press working, each of the plurality of core sheets having a teeth portion corresponding to the teeth; and
an insulating film covering at least a portion of the laminated core corresponding to the teeth, wherein
a burr caused by the press working in each of the plurality of core sheets is located on a side of one end of the laminated core in a laminating direction of the laminated core,
the burr of the teeth portion of one of the plurality of core sheets located at the one end of the laminated core is extended substantially in a direction perpendicular to the laminating direction,
a width of the teeth portion of the one of the plurality of core sheets located at the one end is less than a width of the teeth portion of an other of the plurality of core sheets, and
a tip end of the burr of the teeth portion of the one of the plurality of core sheets is located inside a periphery of the teeth portion of the other of the plurality of core sheets when being viewed in a cross section taken along the laminating direction of the laminated core.

6. A manufacturing method for an armature for a rotary electric apparatus, the method comprising:
laminating a plurality of core sheets in a lamination process, each of the plurality of core sheets being formed by press working to have a teeth portion corresponding to teeth of the armature;
pressing the plurality of core sheets in a laminating direction in a pressing process; and
forming an insulating film on the plurality of core sheets, which are laminated, in a film formation process, wherein
the plurality of core sheets are laminated in the lamination process such that a burr caused by the press working is located at a surface of each of the plurality of core sheets on a side of one end in the laminating direction, and
the burr of the teeth portion of one of the plurality of core sheets located at the one end is pressed in the pressing process such that the burr is folded toward an other end in the laminating direction.

7. The method according to claim 6, wherein
the armature includes a rotor core,
each of the plurality of core sheets includes:
a sheet center portion having a shaft hole; and
the teeth portion radially extended from the sheet center portion, and
a rotation axis is press-fitted in the shaft hole of each of the plurality of core sheets, which are laminated, in the pressing process.

8. A manufacturing method for an armature for a rotary electric apparatus, the method comprising:
laminating a plurality of core sheets in a lamination process, each of the plurality of core sheets being formed by press working to have a teeth portion corresponding to teeth of the armature;
pressing the plurality of core sheets in a laminating direction in a pressing process; and
forming an insulating film on the plurality of core sheets, which are laminated, in a film formation process, wherein
the plurality of core sheets are laminated in the lamination process such that a burr caused by the press working is located at a surface of each of the plurality of core sheets on a side of one end in the laminating direction,
the burr of the teeth portion of a first core sheet of the plurality of core sheets located at the one end in the laminating direction is pressed in the pressing process such that the burr is extended in a direction substantially perpendicular to the laminating direction,
a width of the teeth portion of the first core sheet is less than a width of the teeth portion of a second core sheet of the plurality of core sheets, the second core sheet being adjacent to the first core sheet, and
a tip end of the burr of the teeth portion of the first core sheet is pressed to be located inside a periphery of the teeth portion of the second core sheet.

9. The method according to claim 8, wherein
the armature includes a rotor core,
each of the plurality of core sheets includes:
a sheet center portion having a shaft hole; and
the teeth portion radially extended from the sheet center portion, and
a rotation axis is press-fitted in the shaft hole of each of the plurality of core sheets, which are laminated, in the pressing process.
